(19) United States
(12) Patent Application Publication
(10) Pub. No.: US 2002/0088491 A1
(43) Pub. Date: Jul. 11, 2002

(54) Fluid leakage monitoring system

(76) Inventors: Gennai Yanagisawa, Nagano-ken (JP); Kenichi Kusada, Nagano-ken (JP)

Correspondence Address: William C. Rowland, BURNS, DOANE, SWECKER & MATHIS, L.L.P., P.O. Box 1404, Alexanderia, VA, 22313-1404, US

(21) Appl. No.: 09/756,734

(22) Filed: Jan. 10, 2001

(51) Int. Cl. F16K 17/00

(52) U.S. Cl. 137/456

(57) ABSTRACT

A fluid leakage monitoring system that uses a main flowmeter attached to a main water pipe to measure a flow rate in the main pipe, and secondary flowmeters attached to branch pipes on the downstream side of the main pipe to measure flow rates in each of the branch pipes. The difference between the main pipe flow rate and the branch pipe flow rates is used to determine a fluid leakage flow rate. If the fluid leakage flow rate exceeds a predetermined first flow rate, a shut-off valve on the main pipe is closed.

If the fluid leakage flow rate is less than a predetermined second flow rate, operating a valve release switch by a faucet allows the shut-off valve to be opened for just a specified time. This makes it possible to limit damage caused by a leak from a water pipe, while at the same time ensuring that the minimum amount of water required can be supplied.

### BACKGROUND OF THE INVENTION

1. Field of the Invention

The present invention relates to a fluid leakage monitoring system for preventing damage caused by leakage of water or gas or the like.

2. Related Art Description

In houses, especially houses such as summer houses that are left unused for extended periods, there can happen water leaks caused by, for example, water pipes freezing, causing the pipes to rupture. To prevent damage caused by such leakages, Japanese Utility Model Laid-Open No. Hei-6-12564 discloses a leakage control system that automatically closes a shut-off valve when a leak is detected, and also notifies the management company concerned about the situation. A drawback of this system is that once the shut-off valve closes, it remains closed until the management company completes the repair work, so that during that time, the water system cannot be used at all. This drawback is not limited to water pipes, but also applies in the case of pipes used to carry other fluids such as gas pipes.

### SUMMARY OF THE INVENTION

In view of the above problem, an object of the present invention is to provide a fluid leakage monitoring system that, when a leakage of a fluid occurs, such as a leakage of water from a water pipe, is able to prevent the damage from widening, and is also able to ensure the provision of a sufficient supply of the fluid concerned.

To attain the above object, the present invention provides a fluid leakage monitoring system comprising: a pipe in which a fluid flows; a shut-off valve that can close the pipe; control means for detecting fluid leakage from the pipe and, when leakage is detected, for operating the shut-off valve to close the pipe; and a manually operated shut-off release switch for opening the shut-off valve.

In accordance with this invention, even when the shut-off valve has closed, it can be opened by operating the shut-off release switch, so that even if a fluid leakage occurs, such as a leakage of water, for example, the flow of a required amount of water can still be ensured.

Preferably, the control means is arranged to control the shut-off valve so that when the shut-off release switch is operated, the shut-off valve opens for a predetermined length of time and then reverts to the closed state. If the shut-off valve remains open once the shut-off release switch has been operated, it will result in increasing damage from the leakage. To prevent this, it is therefore desirable for the shut-off valve to revert to the closed state a predetermined time after it has been opened by the operation of the shut-off release switch.

It is also desirable for the fluid leakage monitoring system of this invention to have a flow rate measuring means for measuring the fluid flow in the pipe, with the control means operating the shut-off valve to close the pipe when a fluid leakage flow rate as measured by the flow rate measuring means over a predetermined time period is at or above a predetermined first flow rate.

In this case, it is desirable that, when the pipe is in a closed state and the fluid leakage flow rate as measured by the flow rate measuring means is at or above a predetermined second flow rate that is higher than the first flow rate, the control means does not allow the shut-off valve to open even if the shut-off release switch is operated. This prevents the shut-off valve being opened when there is a very bad leakage.

In a preferred embodiment of this invention, the fluid leakage monitoring system includes a warning means such as a monitor system or the like that warns that there is a fluid leakage, and when the fluid continues to leak at or above a predetermined third flow rate over a predetermined time period that is lower than the first flow rate, the control means operates the warning means to warn that a fluid leakage has occurred.

In another preferred embodiment, the pipe includes a main pipe portion, at least one branch pipe portion connected to the main pipe portion, a fluid outlet formed on the end of the branch pipe portion, and an opening/closing valve for opening and closing the fluid outlet. This arrangement enables a configuration comprising a main flowmeter that measures the flow rate in the main pipe portion, a secondary flowmeter that measures the flow rate in the branch pipe portion, and the control means, which calculates the flow rate of the fluid leakage as the differential between the flow rates measured by the main and secondary flowmeters.

If the pipe includes a plurality of branch pipe portions branching out from the main pipe portion, the opening/closing valves can be located on the main pipe portion and a shut-off release switch assigned to the fluid outlet formed on the end of each branch pipe portion.

In the case of such a configuration, for each shut-off release switch it should be possible to set the length of time that a shut-off valve in the closed state can be kept open.

In a typical arrangement of an embodiment of the invention, the above pipe is a water pipe and the shut-off release switch is located in the vicinity of a faucet on the water pipe. Locating the shut-off release switch near the faucet is convenient, since it enables the switch to be operated when it is desired to use the water.

### BRIEF DESCRIPTION OF THE DRAWINGS

FIG. 1 is a schematic diagram showing the general configuration of a fluid leakage monitoring system according to the present invention.

FIG. 2 is a flow chart of the control process used in the system shown in FIG. 1.

FIG. 3 is a flow chart of the control process used in the control process depicted in FIG. 2 to temporarily open a shut-off valve.

### DETAILED DESCRIPTION OF THE PREFERRED EMBODIMENT

Embodiments of the fluid leakage monitoring system according to the present invention will now be described, with reference to the drawings.

### Overall Configuration

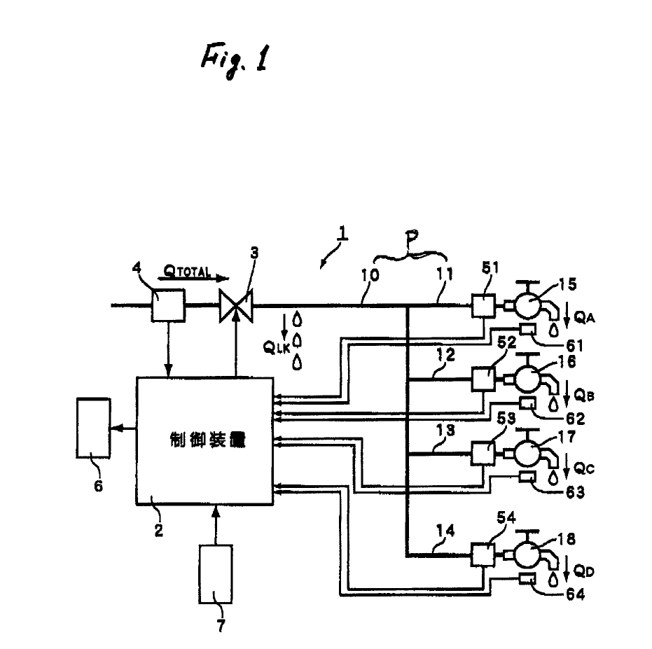

FIG. 1 shows the overall configuration of a fluid leakage monitoring system 1 according to the present invention, adapted to monitor water pipe leakages. A water pipe P being monitored for leakages by the system 1 has a main pipe 10 and first to fourth branch pipes 11 to 14 branching off from the downstream side of the main pipe 10. First to fourth faucets 15 to 18 are affixed to the ends of the respective first to fourth branch pipes 11 to 14. As one example, the faucets 15 to 18 are respectively located at a washbasin, at a washing machine, in a bathroom, and in a kitchen.

In this example, the system 1 has a control unit 2 that monitors and controls shut-off valve 3 attached to the main pipe 10, a main flowmeter 4 attached to the main pipe 10, and first to fourth secondary flowmeters 51 to 54 attached to the respective first to fourth branch pipes 11 to 14. The control unit 2 is constituted by a microcomputer or the like, and performs its monitoring and control of each device in accordance with an internal program. The control unit 2 controls the shut-off valve 3, switching the shut-off valve 3 between a state in which the main pipe 10 is closed and a state in which the main pipe 10 is open. The shut-off valve 3 is normally maintained in the open state.

The control unit 2 monitors the flow rate QTOTAL of the water in the main pipe 10, measured by the main flowmeter 4; and the flow rates QA to QD in the first to fourth branch pipes 11 to 14, as measured by first to fourth secondary flowmeters 51 to 54, thus monitoring the amount of water used via the first to fourth faucets 15 to 18. First to fourth release switches 61 to 64 are attached near the respective faucets 15 to 18. The release switches 61 to 64 are connected to, and thereby monitored by, the control unit 2. When a leakage occurs and the shut-off valve 3 closes, the release switches 61 to 64 are used to temporarily open the shut-off valve 3. Also connected to the control unit 2 are an input panel 7 and a display apparatus 6.

### Operation of the Fluid Leakage Monitoring System

The operation of the fluid leakage monitoring system 1 thus configured is described below.

In the pipes 10 to 14, if there is no water leakage in the pipe sections between the main flowmeter 4 and the secondary flowmeters 51 to 54, flow rate QTOTAL measured by the main flowmeter 4 equals the total of the flow rates QA to QD measured by the secondary flowmeters 51 to 54. Therefore, when there is a leakage in the piping between the main flowmeter 4 and the secondary flowmeters 51 to 54, the amount of the leakage flow QLK can be obtained as follows.

QLK=QTOTAL−(QA+QB+QC+QD)

If the control unit 2 determines that a leakage flow rate QLK has continued to equal or exceed a predetermined first flow rate Qth1 for a specified time period, the shut-off valve 3 is closed. Even after the shut-off valve 3 has been closed, if the control unit 2 determines that the leakage flow rate QLK is lower than a predetermined second flow rate Qth2, if it is detected that any of the release switches 61 to 64 has been pressed, the shut-off valve 3 is opened for a length of time that is preset depending on which of the switches has been pressed. Qth2 is set to be greater than Qth1.

Moreover, if the control unit 2 determines that QLK has continued to equal or exceed a predetermined third flow rate Qth3 for a specified time period, the display apparatus 6 indicates that there is a leakage. Qth3 is set to be smaller than Qth1. The settings of the first to third flow rates Qth1 to Qth3, the time until it is determined that there is a leakage, and the length of time the shut-off valve 3 opens when release switches 61 to 64 are pressed can be varied from the input panel 7.

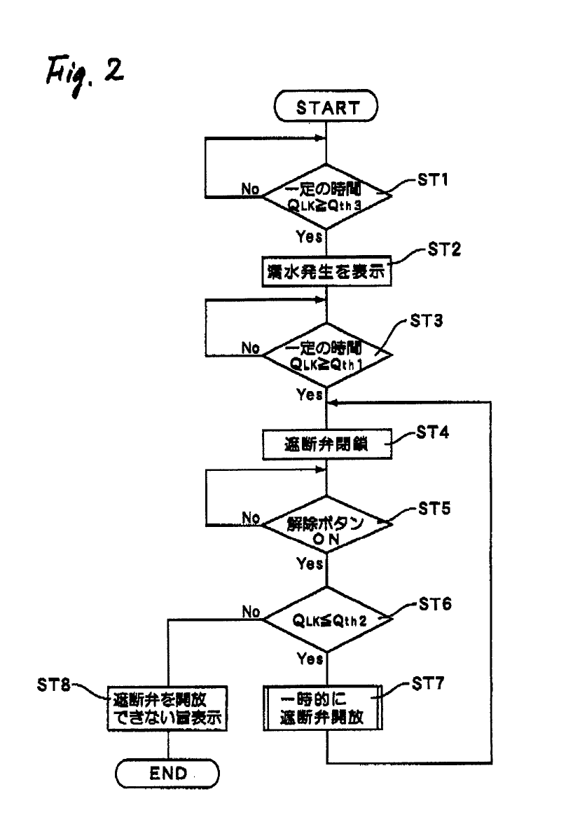

FIG. 2 is a flow chart of the above control process. In step ST1, if it is determined that the leakage flow QLK has continued to equal or exceed third flow rate Qth3 for a specified time period, the display apparatus 6 signifies that a leakage has occurred (step ST2), indicating that a water pipe repair company or the like should be notified. At this point, the water supply can still be used.

Next, in step ST2, if it is determined that QLK has continued to equal or exceed the first flow rate Qth1 for a specified time period, the shut-off valve 3 closes, shutting off the supply of water to the main pipe 10 (step ST4). This stops the leakage.

Next, in step ST5, if it is detected that any of the release switches 61 to 64 has been pressed, in step ST6 it is determined whether or not the previously determined leakage flow QLK is smaller than the second flow rate Qth2. If QLK is larger than the second flow rate Qth2, it means the damage is considerable, so the display apparatus 6 indicates that the shut-off valve 3 cannot be opened (step ST8), and the control process terminates with the shut-off valve 3 remaining closed. In this case, the water supply cannot be used until repairs are carried out.

However, in step ST6, if it is determined that QLK is smaller than flow rate Qth2, the shut-off valve 3 is temporarily opened to allow an amount of water to be used that corresponds to which release switch has been pressed (step ST7).

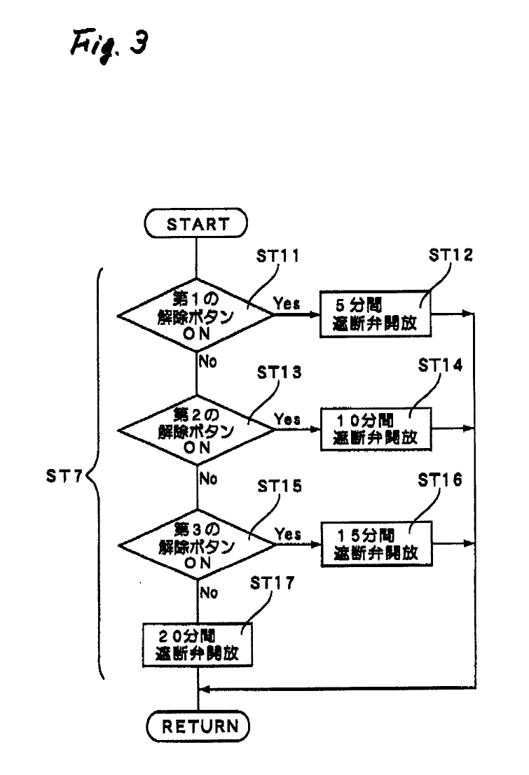

FIG. 3 is a flow chart of the control process used to temporarily open the shut-off valve 3. In step ST11, it is sought to determine if it is the first release switch 61 that has been pressed, in which case, in step ST12, the shut-off valve 3 is opened. The switch 61 is, for example, located by the first faucet 15 at a washbasin. Therefore, if the switch 61 has been pressed, it is taken to signify that there is a desire to use water for washing, and the shut-off valve 3 is set to open for the necessary amount of time, for example five minutes.

If it is not the release switch 61 that has been pressed, in step ST13 it is sought to determine if it is the second release switch 62 that has been pressed, in which case, in step ST14 the shut-off valve 3 is opened. The release switch 62 is located, for example, by the second faucet 16 used for a washing machine. Therefore, if the switch 62 has been pressed, it is taken to signify a desire to use water for the washing machine, so the shut-off valve 3 is set to open accordingly for the necessary amount of time, for example ten minutes.

If it is not the release switch 62 that has been pressed, in step ST15 it is sought to determine if it is the third release switch 63 that has been pressed, in which case, in step ST16 the shut-off valve 3 is opened. The third release switch 63 is located, for example, by the third faucet 17 in a bathroom. Therefore, if the switch 63 has been pressed, it is taken to signify a desire to use water to have a bath, so the shut-off valve 3 is set to open accordingly for the necessary amount of time, for example fifteen minutes.

If it is not the release switch 63 that has been pressed, it is taken to signify that it is the fourth release switch 64 that has been pressed, and the shut-off valve 3 is opened in step ST17. The fourth release switch 64 is located, for example, by the fourth faucet 18 in a kitchen. Therefore, if the switch 64 has been pressed, it is taken to signify a desire to use water for cooking, in which case the shut-off valve 3 is set to open for twenty minutes, for example.

After the shut-off valve 3 has thus been opened for the necessary amount of time for the purpose concerned, in step ST4 (FIG. 2), the shut-off valve 3 is again closed. In this way, even if a leak occurs, if the degree of leakage is small, the water supply can be temporarily used by operating the release switches 61 to 64, making it possible to ensure the minimum amount of water needed for everyday tasks.

In the above embodiment, the main pipe 10 branches into four pipes. However, the number of branches is not limited to four. Moreover, the system can also be configured with no branches. Also, while the above embodiment of the fluid leakage monitoring system has been described with reference to monitoring of water pipe leakages, the system can also be applied to monitor leakages of other fluids carried by pipes, such as liquids and gases.

As described in the foregoing, in accordance with the fluid leakage monitoring system of the present invention, even after a shut-off valve has been closed, operating a release switch enables the valve to be opened, ensuring a supply flow of the fluid even when a leakage has occurred. Also, by arranging the system so that after a release switch has been pressed, the shut-off valve closes after remaining open for a predetermined time, a flow of just the necessary amount of the fluid concerned can be ensured, and any increase in damage caused by the leakage can be controlled.

Moreover, arranging the system so that if the flow rate of the leakage is above a predetermined level, the shut-off valve does not open even if a release switch is pressed makes it possible to prevent the shut-off valve from opening when the extent of the leakage is particularly large. Also, when the system of this invention is applied to a water pipe, it is convenient to locate release switches near faucets, since that enables a release switch to be readily operated when it is desired to use water.

What is claimed is:

1. A fluid leakage monitoring system comprising: a pipe in which a fluid flows; a shut-off valve that can close the pipe; control means for detecting fluid leakage from the pipe and, when leakage is detected, for operating the shut-off valve to close the pipe; and a manually operated shut-off release switch for opening the shut-off valve.

2. A fluid leakage monitoring system according to claim 1, in which the control means controls the shut-off valve so that when the shut-off release switch is operated, the shut-off valve opens for a predetermined length of time and then reverts to the closed state.

3. A fluid leakage monitoring system according to claim 2, comprising a flow rate measuring means for measuring the fluid flow rate in the pipe, in which the control means operating the shut-off valve to close the pipe when a fluid leakage flow rate as measured by the flow rate measuring means over a predetermined time period is at or above a predetermined first flow rate.

4. A fluid leakage monitoring system according to claim 3, in which, when the pipe is in a closed state and the fluid leakage flow rate as measured by the flow rate measuring means is at or above a predetermined second flow rate that is higher than the first flow rate, the control means does not allow the shut-off valve to open even if a shut-off release switch is operated.

5. A fluid leakage monitoring system according to claim 3 or 4, comprising a warning means to warn that there is a fluid leakage, said warning means being operated by the control means to warn that a fluid leakage has occurred when the fluid continues to leak at or above a predetermined third flow rate that over a predetermined time period is lower than the first flow rate.

6. A fluid leakage monitoring system according to claim 3, in which said pipe includes a main pipe portion, at least one branch pipe portion connected to the main pipe portion, a fluid outlet formed on the end of the branch pipe portion, and an opening/closing valve for opening and closing the fluid outlet;
said flow rate measuring means comprising a main flowmeter that measures the flow rate in the main pipe portion, a secondary flowmeter that measures the flow rate in the branch pipe portion, and the control means which calculates the flow rate of the fluid leakage as the differential between the flow rates measured by the main and secondary flowmeters.

7. A fluid leakage monitoring system according to claim 6, in which the pipe includes a plurality of branch pipe portions branching out from the main pipe portion;
the opening/closing valves are located on the main pipe portion; and
a shut-off release switch is assigned to the fluid outlet formed on the end of each branch pipe portion.

8. A fluid leakage monitoring system according to claim 7, in which, a length of time that a shut-off valve in the closed state is kept open is set for each shut-off release switch.

9. A fluid leakage monitoring system according to claim 8, in which said system has an input means for changing said length of time the shut-off valve is kept open by operation of each shut-off release switch.

10. A fluid leakage monitoring system according to claim 3, in which said pipe is a water pipe and said release switch is located in proximity to a faucet on the water pipe.
